(19) United States
(12) Patent Application Publication
(10) Pub. No.: US 2012/0268820 A1
(43) Pub. Date: Oct. 25, 2012

(54) COLOR FILTER FILM, GRATING STRUCTURE AND DISPLAY MODULE

(75) Inventors: Kuang-Heng LIANG, HSINCHU (TW); Heng-Hao CHANG, HSINCHU (TW); Yao-Chou TSAI, HSINCHU (TW)

(73) Assignee: E INK HOLDINGS INC., HSINCHU (TW)

(21) Appl. No.: 13/360,799

(22) Filed: Jan. 29, 2012

(30) Foreign Application Priority Data
Apr. 25, 2011 (TW) 100114320

(51) Int. Cl. G02B 5/26

(52) U.S. Cl. 359/572

(57) ABSTRACT

A grating structure used on a color filter film of a display module is disclosed in the invention. The grating structure is disposed on a substrate of the color filter film. The grating structure includes a plurality of optical transparent layers and an optical reflection layer. The optical transparent layers are stacked on the substrate in sequence. Each of the optical transparent layers has a different refractive index from the other optical transparent layers. The optical reflection layer is disposed over the optical transparent layers.

### RELATED APPLICATIONS

This application claims priority to Taiwan Application Serial Number 100114320, filed Apr. 25, 2011, which is herein incorporated by reference.

### BACKGROUND

1. Field of Invention

The present invention relates to an optical element. More particularly, the present invention relates to a grating structure on a color filter film.

2. Description of Related Art

With the development of electronic technology and the prevalence of consumer electronic products in modem society, the use of various kinds of digital display devices has become widespread. A display device, especially a liquid crystal display (LCD) device, usually includes a color filter film for blocking unnecessary light and for forming different colors.

A color filter film usually includes a grating structure, which can be a black matrix (BM) formed on a surface of a transparent substrate (e.g., glass or plastic sheet). The color filter film may also include stripe-shaped or mosaic-shaped color patterns, for example, red, green and blue color patterns. The size of the color patterns depends on the different uses for and colors of the color filter film.

The black matrix (BM) must provide a high opacity. Utilizing a metal like chromium (Cr) to form the black matrix, such as a Cr-BM, is a common way to form a traditional black matrix. The traditional procedure for forming the black matrix from a Cr-film involves various steps, such as sputtering, spin-coating a positive type photoresist, exposing, developing the photoresist, and etching to remove the positive type photoresist, so as to form a black grating structure pattern. The procedure utilizing a Cr-film for forming the black matrix involves many steps and has low production efficiency. Furthermore, the waste liquid resulting from the etching step may cause environmental problems.

Starting on Jul. 1, 2006, the European Union has forbidden the use of heavy metals like lead, cadmium, mercury and hexavalent chromium in electronic devices. As a result, the Cr-BM must be replaced by a black matrix made using another material. A resin-BM has been used in recent times as a substitute for the Cr-BM.

The procedure for forming the resin-BM mainly involves steps of coating, exposing and developing, such that the procedure for forming the resin-BM involves less equipment costs relative to the procedure for forming the Cr-BM. However, the opacity of the resin-BM is usually poorer than that of the Cr-BM. Therefore, the resin-BM must be increased in thickness to realize the same light-shading effect as the Cr-BM. In general, the thickness of the Cr-BM is around 0.15 μm, while in contrast, the thickness of the resin-BM may be between 1.1 μm and 1.2 μm. Other than the thickness issue, the resin-BM also has additional disadvantages, such as difficulties encountered in maintaining the surface flatness of the resin-BM in a producing procedure, and in adhering the resin-BM to a frame.

### SUMMARY

In order to solve the aforesaid problems, this disclosure provides a color filter film including a grating structure with multiple layers. The color filter film may include an optical reflection layer and multiple optical transparent layers between the optical reflection layer and the glass substrate. The multiple optical transparent layers have different refractive indices for causing optical interference or diffraction phenomena, so as to achieve a light-shading feature with a visible light reflectance of less than 5%.

An aspect of the invention is to provide a color filter film for a display module. The color filter film includes a substrate and a grating structure. The grating structure is disposed on the substrate. The grating structure includes a plurality of optical transparent layers and an optical reflection layer. The optical transparent layers are stacked on the substrate in sequence. Each of the optical transparent layers has a different refractive index from the other optical transparent layers. The optical reflection layer is disposed over the optical transparent layers.

According to an embodiment of this disclosure, each of the optical transparent layers is formed by a transparent dielectric material. The transparent dielectric material may include silicon nitride, silicon oxide or a compound of silicon nitride and silicon oxide.

According to another embodiment of this disclosure, the optical reflection layer is formed by a metal material.

According to another embodiment of this disclosure, the grating structure includes at least three optical transparent layers.

Another aspect of the invention is to provide a grating structure disposed on a substrate of a color filter film. The grating structure includes a plurality of optical transparent layers and an optical reflection layer. The optical transparent layers are stacked on the substrate in sequence. Each of the optical transparent layers has a different refractive index from the other optical transparent layers. The optical reflection layer is disposed over the optical transparent layers.

According to an embodiment of this disclosure, each of the optical transparent layers is formed by a transparent dielectric material. The transparent dielectric material may include silicon nitride, silicon oxide or a compound of silicon nitride and silicon oxide.

According to another embodiment of this disclosure, the optical reflection layer is formed by a metal material.

According to another embodiment of this disclosure, the grating structure includes at least three optical transparent layers.

Another aspect of the invention is to provide a display module. The display module includes a display panel and a color filter film. The color filter film is disposed adjacent to the display panel. The color filter film includes a substrate and a grating structure. The grating structure is disposed between the substrate and the display panel. The grating structure includes a plurality of optical transparent layers and an optical reflection layer. The optical transparent layers are stacked on the substrate in sequence. Each of the optical transparent layers has a different refractive index from the other optical transparent layers. The optical reflection layer is disposed over the optical transparent layers and close to the display panel.

According to an embodiment of this disclosure, each of the optical transparent layers is formed by a transparent dielectric material. The transparent dielectric material may include silicon nitride, silicon oxide or a compound of silicon nitride and silicon oxide.

According to another embodiment of this disclosure, the optical reflection layer is formed by a metal material.

According to another embodiment of this disclosure, the grating structure includes at least three optical transparent layers.

The application of the disclosure has various advantages. In an embodiment of the disclosure, the optical reflection layer made by a metal material may form a smooth surface on the grating structure, such that the production procedure of the grating structure may have a high stability. Furthermore, the differences in the refractive indices between the optical transparent layers can be utilized to reduce the visible light reflectance, so as to achieve the feature of light shading. Therefore, a coating procedure involving chromium (Cr) or other heavy metals is unneeded in this disclosure. In addition, a dark paint coating procedure is not required in this disclosure. Hence, the application of this disclosure is environmentally friendly.

### BRIEF DESCRIPTION OF THE DRAWINGS

The invention can be more fully understood by reading the following detailed description of the embodiment, with reference made to the accompanying drawings as follows:

FIG. 1 is a sectional diagram illustrating a grating structure according to an embodiment of the invention;

FIG. 2 is a sectional diagram illustrating a color filter film according to an embodiment of the invention; and

FIG. 3 is a sectional diagram illustrating a display module according to an embodiment of the invention.

### DETAILED DESCRIPTION

In order to achieve aforesaid effects, a color filter film and a display module are provided in this invention, which discloses a grating structure that includes multiple layers with different refractive indices. The multiple layers with different refractive indices can be used to reduce visible light reflectance through optical interference or optical diffraction. Details and embodiments of the invention are disclosed below.

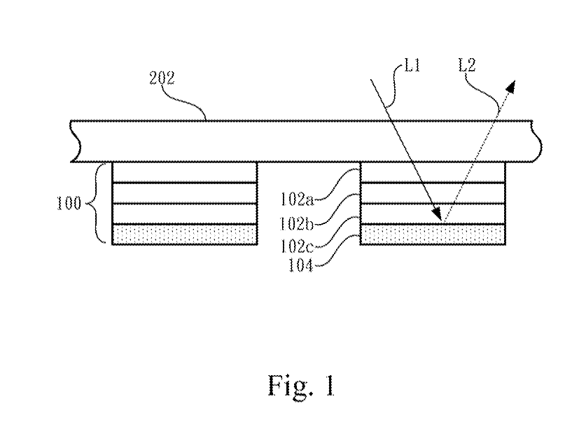

FIG. 1 is a sectional diagram illustrating a grating structure 100 according to an embodiment of the invention. The grating structure 100 can be disposed on a substrate 202 of a color filter film. In actual applications, the substrate 202 can be a glass substrate, a transparent plastic substrate or a transparent substrate made by other materials. The grating structure 100 may serve as a black matrix (BM) in various different kinds of display devices. The grating structure 100 includes a plurality of optical transparent layers and an optical reflection layer 104. In this embodiment, the grating structure 100 includes three optical transparent layers, namely, optical transparent layers 102a, 102b and 102c shown in FIG. 1. However, the invention is not limited to three layers. The optical transparent layer 102a, the optical transparent layer 102b and the optical transparent layer 102c are stacked on the substrate 202 in sequence. The optical reflection layer 104 is disposed over the optical transparent layers 102a, 102b and 102c. In this embodiment, the optical reflection layer 104 is disposed on the outermost optical transparent layer 102c.

Each of the optical transparent layers 102a, 102b and 102c is formed by a transparent dielectric material. The transparent dielectric material may include silicon nitride (SiₓN), silicon oxide (SiₓO) or a compound of these two materials. It is to be noted that each of the optical transparent layer 102a, the optical transparent layer 102b and the optical transparent layer 102c has a refractive index different from the other two optical transparent layers 102b and 102c, 102a and 102c, or 102a and 102b. The differences in the refractive indices among the optical transparent layers 102a, 102b and 102c can be realized by selecting materials with different refractive indices, mixing materials in different ratios, or other equivalent means during the producing procedure.

The optical reflection layer 104 can be formed by a metal material. The optical reflection layer 104 in the embodiment does not need any coating or surface-processing step. Therefore, heavy metal pollution and related environmental problems encountered in traditional applications can be prevented in the embodiment of this disclosure. Since a coating or surface-processing step is unneeded in the embodiment, the original color of the metal material used for the optical reflection layer 104 may be preserved.

A diffraction phenomenon will occur with respect to a visible inlet light L1 when the visible inlet light L1 from the substrate 202 (e.g., glass substrate) passes through the multiple-layer transparent structure with different refractive indices (i.e., when the visible inlet light L1 passes through the optical transparent layer 102a, the optical transparent layer 102b and the optical transparent layer 102c). The inlet light L1 is subsequently projected on the reflection layer 104, which is made of a metal material, so as to generate reflection light L2. A destructive optical interference phenomenon occurs between the reflection light L2 and other inlet light. The luminance of the reflection light L2 is less than 5% of the luminance of the inlet light L1.

In other words, the grating structure 100 (multiple optical transparent layers and the optical reflection layer 104) in the embodiment has a visible light reflectance of less than 5%. When a user performs a naked-eye observation of the display region implemented with the grating structure 100, the display region will appear virtually black because the display region has a low visible light reflectance. Hence, the light-shading feature of the grating structure 100 is realized.

Furthermore, the optical reflection layer 104 made by a metal material has a smooth and flat surface. The optical reflection layer 104 does not need any coating or surface-processing step, such that heavy metal pollution and related environmental problems encountered in traditional applications can be prevented in the embodiment of this disclosure.

In addition, the optical transparent layers 102a, 102b, 102c and the optical reflection layer 104 in the grating structure 100 according to the embodiment of the invention are able to achieve a visible light reflectance of less than 5% using a total thickness of only 0.3 μm to 0.4 μm. The total thickness of the optical transparent layers 102a, 102b, 102c and the optical reflection layer 104 is less than the thickness (about 1.1 μm to 1.2 μm) of a resin-BM in the prior art. In another embodiment, more optical transparent layers (e.g., four optical transparent layers or more) can be stacked for a better light-shading effect.

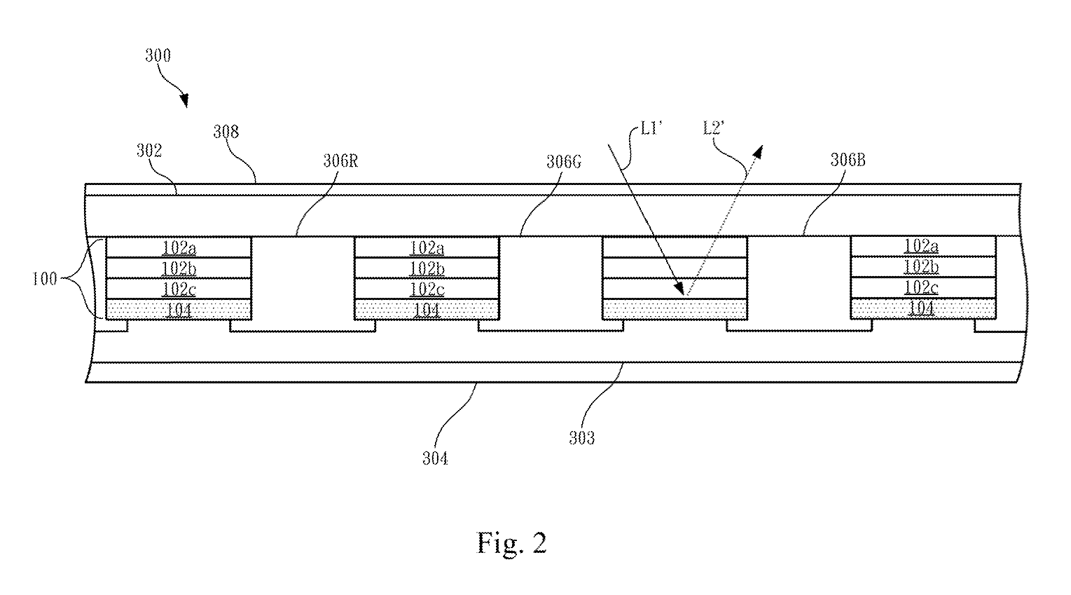

FIG. 2 is a sectional diagram illustrating a color filter film 300 according to an embodiment of the invention. As shown in FIG. 2, the color filter film 300 includes the grating structure 100 described in the aforesaid embodiment. Details of the grating structure 100 can be appreciated by referring to the previous paragraphs, and will not to be repeated.

As shown in FIG. 2, the color filter film 300 in the embodiment mainly includes a substrate 302 and the grating structure 100 disposed on the substrate 302. In addition, the color filter film 300 further includes other optical film layers, such as a protective layer 303, a transparent electrode layer 304, pixel regions (e.g., pixel regions 306R, 306G and 306B) and a polarizer 308 so as to satisfy the requirements for actual applications. However, the invention is not limited in this regard. The substrate 302 can be a glass substrate, a transparent plastic substrate or a transparent made by other materials.

A diffraction phenomenon will occur with respect to a visible inlet light L1′ when the visible inlet light L1′ from the substrate 302 passes through the multiple-layer transparent structure with different refractive indices. The inlet light L1′ is subsequently reflected by the grating structure 100, so as to generate the reflection light L2′. A destructive optical interference phenomenon occurs between the reflection light L2′ and other inlet light. The luminance of the reflection light L2′ is less than 5% of the luminance of the inlet light L1′.

Therefore, the embodiment with the multilayer grating structure in the invention may achieve a light-shading effect with a visible light reflectance of less than 5%. In addition, the color filter film 300 is thin, stable during the production process and free from environmental issues.

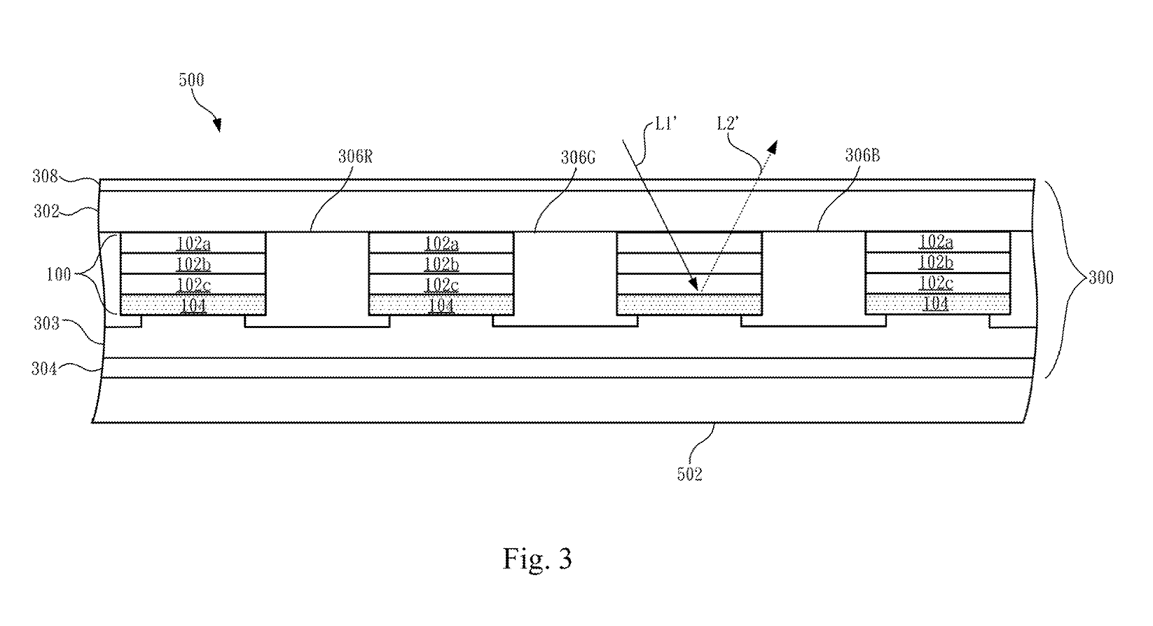

FIG. 3 is a sectional diagram illustrating a display module 500 according to an embodiment of the invention. As shown in FIG. 3, the display module 500 includes a display panel 502 and the color filter film 300 disclosed in the previous embodiment. The color filter film 300 may further include the grating structure 100 in the aforesaid embodiment. Details of the color filter film 300 and the grating structure 100 can be appreciated by referring to the previous paragraphs, and will not be repeated.

In the embodiment, the display panel 502 of the display module 500 can be a thin film transistor liquid crystal display (TFT-LCD) panel, an electronic paper panel, an active-matrix organic light-emitting diode (AMOLED) panel or any other equivalent display panel. In the example shown in FIG. 3, the display panel 502 is a liquid crystal display panel. The display module 500 may further include a pixel driver circuit, a backlight source and a backlight driver circuit (not shown), but the invention is not limited in this regard. For example, the backlight components can be omitted in the electronic paper panel or the AMOLED panel.

In the embodiment, the color filter film 300 is disposed adjacent to the display panel 502. The color filter film 300 includes a substrate 302 and a grating structure 100. The grating structure 100 is disposed between the substrate 302 and the display panel 502. The grating structure 100 includes a plurality of optical transparent layers (e.g., the optical transparent layers 102a, 102b and 102c) and an optical reflection layer 104. The optical transparent layers 102a, 102b and 102c are stacked on the substrate 302 in sequence. Each of the optical transparent layers 102a, 102b and 102c has a different refractive index from the other two optical transparent layers 102b and 102c, 102a and 102c, or 102a and 102b. The optical reflection layer 104 is disposed on the outermost optical transparent layer 102c and is close to the display panel 502. As shown in FIG. 3, the color filter film 300 further includes other optical film layers, such as a protective layer 303, a transparent electrode layer 304, pixel regions (e.g., pixel regions 306R, 306G and 306B) and a polarizer 308.

The display module including the color filter film with the multilayer grating structure may achieve a light-shading effect with a visible light reflectance of less than 5%. In addition, the display module of the invention is thin, stable during the production process and free from environmental issues, such that the display module is suitable for use in various kinds of display devices.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A color filter film for a display module, the color filter film comprising:
a substrate; and
a grating structure disposed on the substrate, the grating structure comprising:
a plurality of optical transparent layers stacked on the substrate in sequence, each of the optical transparent layers having a different refractive index from the other optical transparent layers; and
an optical reflection layer disposed over the optical transparent layers.

2. The color filter film of claim 1, wherein each of the optical transparent layers is formed by a transparent dielectric material.

3. The color filter film of claim 2, wherein the transparent dielectric material comprises silicon nitride, silicon oxide or a compound of silicon nitride and silicon oxide.

4. The color filter film of claim 1, wherein the optical reflection layer is formed by a metal material.

5. The color filter film of claim 1, wherein the grating structure comprises at least three optical transparent layers.

6. A grating structure disposed on a substrate of a color filter film, the grating structure comprising:
a plurality of optical transparent layers stacked on the substrate in sequence, each of the optical transparent layers having a different refractive index from the other optical transparent layers; and
an optical reflection layer disposed over the optical transparent layers.

7. The grating structure of claim 6, wherein each of the optical transparent io layers is formed by a transparent dielectric material.

8. The grating structure of claim 7, wherein the transparent dielectric material comprises silicon nitride, silicon oxide or a compound of silicon nitride and silicon oxide.

9. The grating structure of claim 6, wherein the optical reflection layer is formed by a metal material.

10. The grating structure of claim 6, wherein the grating structure comprises at least three optical transparent layers.

11. A display module, comprising:
a display panel; and
a color filter film disposed adjacent to the display panel, the color filter film comprising:
a substrate; and
a grating structure disposed between the substrate and the display panel, the grating structure comprising:
a plurality of optical transparent layers stacked on the substrate in sequence, each of the optical transparent layers having a different refractive index from the other optical transparent layers; and
an optical reflection layer disposed over the optical transparent layers and close to the display panel.

12. The display module of claim 11, wherein each of the optical transparent layers is formed by a transparent dielectric material.

13. The display module of claim 12, wherein the transparent dielectric material comprises silicon nitride, silicon oxide or a compound of silicon nitride and silicon oxide.

14. The display module of claim 11, wherein the optical reflection layer is formed by a metal material.

15. The display module of claim 11, wherein the grating structure comprises at least three optical transparent layers.
